(19) United States
(12) Patent Application Publication
(10) Pub. No.: US 2023/0114373 A1
(43) Pub. Date: Apr. 13, 2023

(54) DEMODULATOR TYPE REPORT WITH NEGATIVE ACKNOWLEDGEMENT (NACK)

(71) Applicant: QUALCOMM Incorporated, San Diego, CA (US)

(72) Inventors: Jacob PICK, Beit Zayit (IL); Shay LANDIS, Hod Hasharon (IL); Shlomit SHAKED, Rosh Haayin (IL); Michael LEVITSKY, Rehovot (IL); Daniel PAZ, Geva Carmel (IL)

(21) Appl. No.: 17/497,584

(22) Filed: Oct. 8, 2021

(51) Int. Cl. H04L 1/16; H04W 72/04; H04W 8/24

(52) U.S. Cl. CPC H04L 1/1607; H04W 72/04; H04W 8/24

(57) ABSTRACT

Aspects relate to techniques for a user equipment (UE) to report a demodulator type associated with a negative acknowledgement (NACK) to a base station. The UE may provide an indicator of the demodulator type utilized by the UE in demodulating an initial transmission of a transport block within feedback information including a NACK associated with the initial transmission. The base station may transmit a retransmission of the transport block based on the NACK and the demodulator type.

### TECHNICAL FIELD

The technology discussed below relates generally to wireless communication systems, and more particularly, to reporting a demodulator type utilized by a user equipment (UE) in demodulating a transport block with a negative acknowledgement (NACK) to a base station.

### INTRODUCTION

Fifth Generation (5G) New Radio (NR) networks employ various mechanisms to maximize throughput and minimize delay. One such mechanism is the Hybrid Automatic Repeat Request (HARQ) process, which may combine both Forward Error Correction (FEC) and Automatic Repeat Request (ARQ) to correct errors in received packets. FEC adds redundancy (parity bits) to the transmitted data to enable a certain amount of erroneously received bits to be corrected at the receiver. If a packet arrives having a higher number of errors than can be corrected using FEC, the ARQ process is initiated to request a retransmission of the packet from the sender.

In general, HARQ uses a stop and wait (SAW) protocol, in which a transmitting entity waits to receive an acknowledged (ACK) or not acknowledged (NACK) back from the receiving entity before transmitting another packet or retransmitting the same packet. For example, in response to a NACK, the transmitting device may send a HARQ retransmission, which may implement chase combining, incremental redundancy, etc. To fully utilize the bandwidth and increase throughput, multiple parallel HARQ processes may be initiated offset in time from one another. Each HARQ process is identified by a unique HARQ process identifier (ID).

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a radio access network (RAN) node configured for wireless communication is provided. The RAN node includes a transceiver, a memory, and a processor coupled to the transceiver and the memory. The processor and the memory are configured to transmit an initial transmission of a transport block to a user equipment (UE) via the transceiver, and receive, from the UE, feedback information including a negative acknowledgement (NACK) associated with the initial transmission and an indicator of a demodulator type utilized by the UE in demodulating the transport block via the transceiver. The processor and the memory are further configured to transmit a retransmission of the transport block based on the NACK and the demodulator type to the UE via the transceiver.

Another example provides a method of wireless communication at a radio access network (RAN) node. The method includes transmitting an initial transmission of a transport block to a user equipment (UE) and receiving, from the UE, feedback information including a negative acknowledgement (NACK) associated with the initial transmission and an indicator of a demodulator type utilized by the UE in demodulating the transport block. The method further includes transmitting a retransmission of the transport block based on the NACK and the demodulator type.

Another example provides a user equipment (UE) configured for wireless communication. The UE includes a transceiver, a memory, and a processor coupled to the transceiver and the memory. The processor and the memory are configured to receive an initial transmission of a transport block from a radio access network (RAN) node, and transmit, to the RAN node, feedback information including a negative acknowledgement (NACK) associated with the initial transmission and an indicator of a demodulator type utilized by the UE in demodulating the transport block. The processor and the memory are further configured to receive a retransmission of the transport block based on the NACK and the demodulator type.

Another example provides a method of wireless communication at a user equipment (UE). The method includes receiving an initial transmission of a transport block from a radio access network (RAN) node, and transmitting, to the RAN node, feedback information including a negative acknowledgement (NACK) associated with the initial transmission and an indicator of a demodulator type utilized by the UE in demodulating the transport block. The method further includes receiving a retransmission of the transport block based on the NACK and the demodulator type.

These and other aspects of the invention will become more fully understood upon a review of the detailed description, which follows. Other aspects, features, and examples will become apparent to those of ordinary skill in the art, upon reviewing the following description of specific, exemplary examples in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. In similar fashion, while exemplary examples may be discussed below as device, system, or method examples it should be understood that such exemplary examples can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a schematic illustration of an organization of wireless resources in an air interface utilizing orthogonal frequency divisional multiplexing (OFDM) according to some aspects.

FIG. 4 is a block diagram illustrating a wireless communication system supporting beamforming and/or multiple-input multiple-output (MIMO) communication according to some aspects.

FIG. 5 is a conceptual diagram illustrating an example of a transmitting device configured to transmit a transport block according to some aspects.

FIG. 6 is a diagram illustrating an example of a transport block including code block groups (CBGs) according to some aspects.

FIG. 7 is a schematic illustration of a wireless communication system as may be implemented between a transmitting device and a receiving device within a radio access network, according to some aspects.

FIG. 8 is a diagram illustrating exemplary signaling for reporting a demodulator type from a UE to a radio access network (RAN) node according to some aspects.

FIGS. 9A and 9B are diagrams illustrating exemplary HARQ feedback information according to some aspects.

FIG. 10 is a block diagram illustrating an example of a hardware implementation for a radio access network (RAN) node employing a processing system according to some aspects.

FIG. 11 is a flow chart illustrating an exemplary process for reporting a demodulator type with a negative acknowledgement (NACK) according to some aspects.

FIG. 12 is a block diagram illustrating an example of a hardware implementation for a UE employing a processing system according to some aspects.

FIG. 13 is a flow chart illustrating another exemplary process for reporting a demodulator type with a NACK according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, examples and/or uses may come about via integrated chip examples and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc. of varying sizes, shapes and constitution.

In various examples, a user equipment (UE) may support multiple demodulator types, such as a minimum-mean-squared-error (MMSE) demodulator and a maximum likelihood (ML) demodulator. The UE may further have a capability to dynamically switch between demodulator types for demodulating different received signals. For example, the UE may utilize a first demodulator type to demodulate a first received signal at a first time and dynamically switch to a second demodulator type to demodulate a second received signal at a second time. Since the UE may dynamically switch between the available (supported) demodulators, the base station is unaware of the particular demodulator type utilized by the UE in demodulating a received signal (e.g., a transport block).

Therefore, various aspects relate to reporting the demodulator type utilized by the UE in demodulating a transport block to the base station. The UE may provide the demodulator type together with a negative acknowledgement (NACK) associated with the transport block in response to a failure to decode the transport block at the UE. With knowledge of the demodulator type, the base station may adjust one or more transmission parameters for a retransmission of the transport block to attempt to reduce the number of retransmissions. For example, the base station may adjust one or more of a precoding parameter, a redundancy version, or a modulation order based on the demodulator type. Thus, by including a new demodulator type feedback with the NACK, the UE performance, the network throughput and coverage, and the overall network capacity may be improved. In some examples, the base station may further utilize the demodulator type to improve an outer-loop link adaptation convergence.

In some examples, the UE may provide a single demodulator type utilized for the entire transport block or a respective demodulator type utilized for each code block group (CBG) of the transport block for which a NACK is transmitted. In some examples, the UE may further provide a list of demodulator types supported by the UE to the base station. For example, the UE may provide the list of demodulator types within a UE capability information message (e.g., a radio resource control (RRC) configuration message) or within a physical uplink shared channel (PUSCH) prior to RRC configuration of the UE.

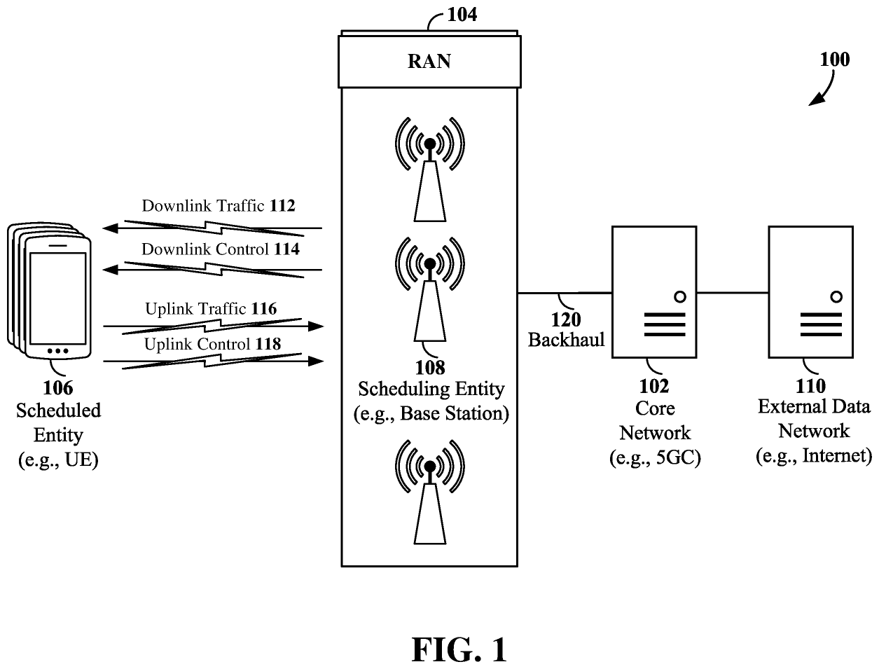

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long Term Evolution (LTE). The 3GPP refers to this hybrid RAN as a next-generation RAN, or NO-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations may be an LTE base station, while another base station may be a 5G NR base station.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a base station (e.g., base station 108) to one or more UEs (e.g., similar to UE 106) may be referred to as downlink (DL) transmission. In accordance with certain aspects of the present disclosure, the term downlink may refer to a point-to-multipoint transmission originating at a base station (e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs 106). That is, for scheduled communication, a plurality of IEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, a scheduling entity 108 may broadcast downlink traffic 112 to one or more scheduled entities (e.g., one or more UEs 106). Broadly, the scheduling entity 108 is a node or device responsible for scheduling traffic in a wireless communication network, including the downlink traffic 112 and, in some examples, uplink traffic 116 from one or more scheduled entities (e.g., one or more UEs 106) to the scheduling entity 108. On the other hand, the scheduled entity (e.g., a UE 106) is a node or device that receives downlink control information 114, including but not limited to scheduling information (e.g., a grant), synchronization or timing information, or other control information from another entity in the wireless communication network such as the scheduling entity 108. The scheduled entity 106 may further transmit uplink control information 118, including but not limited to a scheduling request or feedback information, or other control information to the scheduling entity 108.

In addition, the uplink and/or downlink control information 114 and/or 118 and/or traffic 112 and/or 116 information may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system 100. The backhaul portion 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

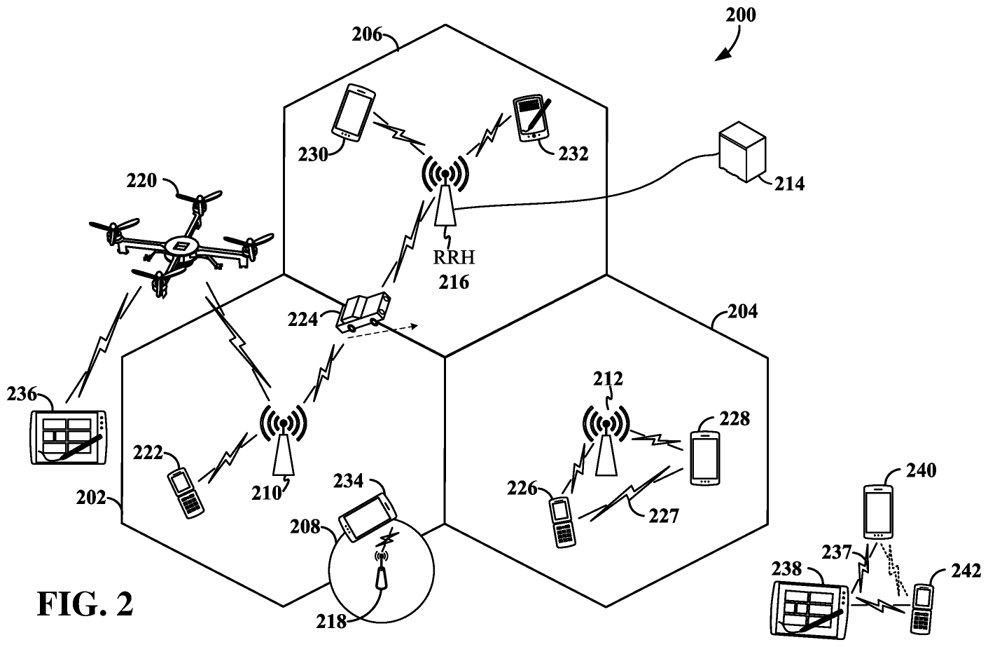

Referring now to FIG. 2, as an illustrative example without limitation, a schematic illustration of a radio access network (RAN) 200 according to some aspects of the present disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations, base station 210 and base station 212 are shown in cells 202 and 204. A third base station, base station 214 is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the scheduling entity 108 described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as or similar to the UE/scheduled entity 106 described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCHs)). The UEs 222, 224, 226, 228, 230, and 232 may receive the unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP-OFDM). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

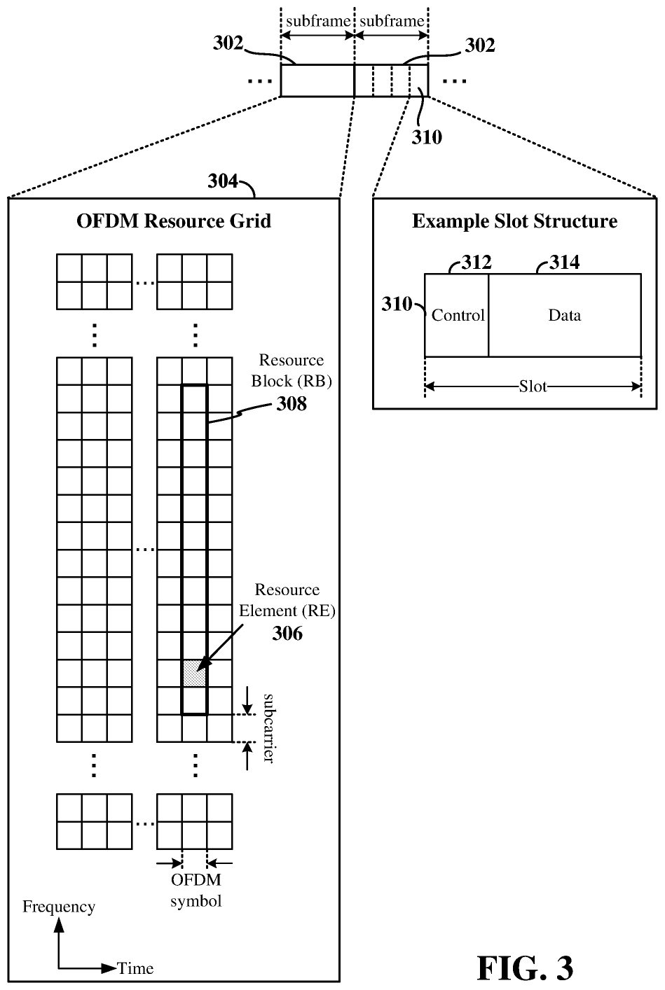

Various aspects of the present disclosure will be described with reference to an OFDM waveform, schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a base station (e.g., gNB, eNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely exemplary in nature, and different slot structures may be utilized, and may include one or more of each of the control region(s) and data region(s).

Although not illustrated in FIG. 3, the various REs 306 within a RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry HARQ feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission.

There are two main types or categories of HARQ algorithms: chase-combining HARQ (HARQ-CC) and incremental redundancy HARQ (HARQ-IR). In HARQ-CC, a retransmitted codeword is identical to the original transmission of the codeword. That is, if a codeword is not decoded properly at the receiving device, resulting in a NACK, then the transmitting device may retransmit the full codeword (e.g., encoded packet or transport block) including identical information to the original transmission. The information may then ideally be obtained error-free by virtue of a process called soft combining, where the redundant bits from the retransmission may be combined before decoding to increase the probability of correct reception of each bit.

On the other hand, in HARQ-IR, the retransmission may be different from the original transmission, and further, if multiple retransmissions are made, each retransmission may differ from one another. Here, retransmissions may include different sets of coded bits: for example, corresponding to different sets parity bits. As with HARQ-CC, here, the information may be obtained error-free by utilizing soft combining to combine the retransmitted bits with the original transmitted bits.

Each HARQ-IR transmission is typically referred to as a redundancy version, with the initial transmission of a packet being denoted RV0 (e.g., the initial redundancy version). The first IR retransmission of the packet may be referred to as RV1, the second IR retransmission of the packet may be referred to as RV2, and so on, up to RVN, corresponding to the maximum number of retransmissions allowed before the packet is considered lost. Each redundancy version (RV0, RV1, . . . RVN) may include different encoded bits, comprised of systematic bits and/or parity bits.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 306 to carry UL control information (UCI) including one or more UL control channels, such as a physical uplink control channel (PUCCI), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a proximity service (ProSe) PC5 interface, the control region 312 of the slot 310 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 314 of the slot 310 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

The channels or carriers illustrated in FIG. 3 are not necessarily all of the channels or carriers that may be utilized between devices, and those of ordinary skill in the art will recognize that other channels or carriers may be utilized in addition to those illustrated, such as other traffic, control, and feedback channels.

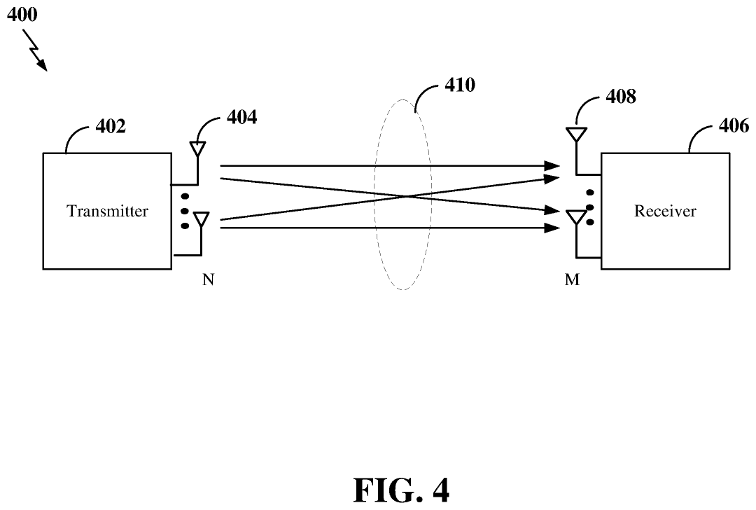

In some aspects of the disclosure, the scheduling entity and/or scheduled entity may be configured for beamforming and/or multiple-input multiple-output (MIMO) technology. FIG. 4 illustrates an example of a wireless communication system 400 supporting beamforming and/or MIMO. In a MIMO system, a transmitter 402 includes multiple transmit antennas 404 (e.g., N transmit antennas) and a receiver 406 includes multiple receive antennas 408 (e.g., M receive antennas). Thus, there are N×M signal paths 410 from the transmit antennas 404 to the receive antennas 408. Each of the transmitter 402 and the receiver 406 may be implemented, for example, within a scheduling entity, a scheduled entity, or any other suitable device. In some examples, the transmitter and receiver are each wireless communication devices (e.g., UEs or V2X devices) communicating over a sidelink channel.

The use of such multiple antenna technology enables the wireless communication system to exploit the spatial domain to support spatial multiplexing, beamforming, and transmit diversity. Beamforming is a signal processing technique that may be used at the transmitter 402 or receiver 406 to shape or steer an antenna beam (e.g., a transmit beam or receive beam) along a spatial path between the transmitter 402 and the receiver 406. Beamforming may be achieved by combining the signals communicated via antennas 404 or 408 (e.g., antenna elements of an antenna army module) such that some of the signals experience constructive interference while others experience destructive interference. To create the desired constructive/destructive interference, the transmitter 402 or receiver 406 may apply amplitude and/or phase offsets to signals transmitted or received from each of the antennas 404 or 408 associated with the transmitter 402 or receiver 406.

A base station (e.g., gNB) may generally be capable of communicating with UEs using beams of varying beam widths. For example, a base station may be configured to utilize a wider beam when communicating with a UE that is in motion and a narrower beam when communicating with a UE that is stationary. In some examples, to select a particular beam for communication with a UE, the base station may transmit a reference signal, such as a synchronization signal block (SSB) or channel state information—reference signal (CSI-RS), on each of a plurality of beams in a beam-sweeping manner. The UE may measure the reference signal received power (RSRP) or signal-to-interference-plus-noise (SINR) on each of the beams and transmit a beam measurement report, such as a Layer 1 (L1) measurement report, to the base station indicating the RSRP or SINR of each of the measured beams. The base station may then select the particular beam for communication with the UE based on the beam measurement report. In other examples, when the channel is reciprocal, the base station may derive the particular beam to communicate with the UE based on uplink measurements of one or more uplink reference signals, such as a sounding reference signal (SRS).

In 5G New Radio (NR) systems, particularly for FR2 (millimeter wave) systems, beamformed signals may be utilized for most downlink channels, including the physical downlink control channel (PDCCH) and physical downlink shared channel (PDSCH). In addition, broadcast control information, such as the synchronization signal block (SSB), slot format indicator (SFI), and paging information, may be transmitted in a beam-sweeping manner to enable all scheduled entities (UEs) in the coverage area of a transmission and reception point (TRP) (e.g., a gNB) to receive the broadcast control information. In addition, for UEs configured with beamforming antenna arrays, beamformed signals may also be utilized for uplink signals and channels, including the physical uplink control channel (PUCCH), physical uplink shared channel (PUSCH), and sounding reference signal (SRS). In addition, beamformed signals may further be utilized in D2D systems, such as NR sidelink (SL) or V2X, utilizing FR2.

Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO). This is achieved by spatially precoding each data stream (i.e., multiplying the data streams with different weighting and phase shifting) and then transmitting each spatially precoded stream through multiple transmit antennas on the downlink. The spatially precoded data streams arrive at the UE(s) with different spatial signatures, which enables each of the UE(s) to recover the one or more data streams destined for that UE. On the uplink, each UE transmits a spatially precoded data stream, which enables the base station to identify the source of each spatially precoded data stream.

The number of data streams or layers corresponds to the rank of the transmission. In general, the rank of the wireless communication system 400 is limited by the number of transmit or receive antennas 404 or 408, whichever is lower. In addition, the channel conditions at the UE, as well as other considerations, such as the available resources at the base station, may also affect the transmission rank. For example, the rank (and therefore, the number of data streams) assigned to a particular UE on the downlink may be determined based on the rank indicator (RI) transmitted from the UE to the base station. The RI may be determined based on the antenna configuration (e.g., the number of transmit and receive antennas) and a measured signal-to-interference-and-noise ratio (SINR) on each of the receive antennas. The RI may indicate, for example, the number of layers that may be supported under the current channel conditions. The base station may use the RI, along with resource information (e.g., the available resources and amount of data to be scheduled for the UE), to assign a transmission rank to the UE.

In Time Division Duplex (TDD) systems, the UL and DL are reciprocal, in that each uses different time slots of the same frequency bandwidth. Therefore, in TDD systems, the base station may assign the rank for DL MIMO transmissions based on UL SINR measurements (e.g., based on a Sounding Reference Signal (SRS) transmitted from the UE or other pilot signal).

In one example, as shown in FIG. 4, a rank-2 spatial multiplexing transmission on a 2×2 MIMO antenna configuration will transmit one data stream from each transmit antenna 404. Each data stream reaches each receive antenna 408 along a different signal path 410. The receiver 406 may then reconstruct the data streams using the received signals from each receive antenna 408.

Based on the assigned rank, the base station may then transmit channel state information reference signals (CSI-RSs) with separate C-RS sequences for each layer to provide for multi-layer channel estimation. From the CSI-RSs, the UE may measure the channel quality across layers and resource blocks and feed back the RI and a channel quality indicator (CQI) that indicates to the base station a modulation and coding scheme (MCS) to use for transmissions to the UE for use in updating the rank and assigning REs for future downlink transmissions. The RI and CQI may be transmitted, for example, within a channel state information (CSI) report. The CSI report may further include a precoding matrix indicator (PMI) that indicates to the base station the precoding matrix to use for transmissions to the JE, and other suitable parameters.

For MIMO transmissions, each layer (or data stream) may be mapped to one of a plurality of antenna ports on the scheduling entity (e.g., transmitter 402). For example, the transmit antennas 404 may be mapped to antenna ports on the transmitter 402. Here, the term antenna port refers to a logical port (e.g., a beam) over which a signal (e.g., a data stream or layer) may be transmitted. In an example, an antenna array on the scheduling entity may include 128 transmit antennas 404 (e.g., antenna elements within a 16×8 array) that may be mapped to 42 antenna ports by an 8×1 combiner.

The scheduling entity (e.g., transmitter 402) may maintain a codebook of precoding matrices and map the different transmission layers to a set of antenna ports on the scheduling entity using a selected precoding matrix. The precoding matrix provides the appropriate weightings to be applied to each layer for generation of the respective beam for each layer. The precoding matrix may be selected based on the PMI fed back from the scheduled entity in the CSI report. For example, using the PMI, the scheduling entity may select a particular precoding matrix from a codebook for a MIMO transmission.

Many different codebooks may be used. In some scenarios, codebooks can be Type 1 codebooks (single panel or multi-panel) or Type II codebooks. Type I codebooks include predefined precoding matrices based on the number of layers and antenna ports. Type II codebooks also include precoding matrices based on the number of layers and antenna ports. However, with Type II codebooks, the scheduling entity uses wideband and sub-band indices fed back from the scheduled entity (e.g., receiver 406) to calculate the respective weightings applied to each layer for improved beamforming.

Codebooks may also have additional features. For example, utilized codebook types can be designed based on 1D/2D discrete Fourier transform (DFT) vectors, and hence assume that a uniform linear or planar antenna array is employed at the scheduling entity. Since a wide variety of 2D antenna array dimensions are available, the codebooks may be configurable and scalable. That is, the antenna port layout of an antenna panel in vertical and horizontal dimensions (N₁ and N₂, respectively) may be explicitly configured as part of the codebook configuration. For a multi-panel codebook, the number of panels N_{g} is also configured. Assuming that dual-polarized antenna arrays are used, the total number of antenna ports (P) used by the codebook may be represented as P=2N_{g}N₁N₂, where N_{g}=1 for single panel and Type II codebooks.

The physical channels described above are generally multiplexed and mapped to transport channels for handling at the medium access control (MAC) layer. Transport channels carny blocks of information called transport blocks (TB). The transport block size (TBS), which may correspond to a number of bits of information, may be a controlled parameter, based on the modulation and coding scheme (MCS) and the number of RBs in a given transmission.

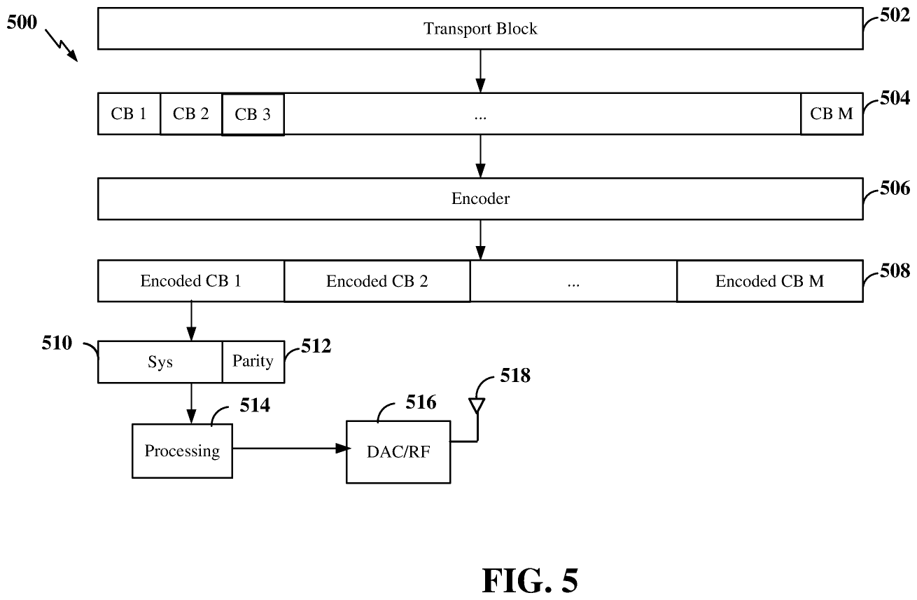

FIG. 5 is a conceptual diagram illustrating a transmitting device 500 configured to transmit a transport block 502 according to some aspects. The transmitting device 500 may correspond to, for example, any of the base stations or scheduling entities shown in FIGS. 1 and/or 2 or any of the UEs or scheduled entities shown in FIGS. 1 and/or 2.

The transport block 502 may include a packet, such as an Internet Protocol (IP) packet, a radio link control (RLC) protocol data unit (PDU), or a medium access control (MAC) PDU. The transmitting wireless communication device 500 may be configured to segment the transport block 502 into M code blocks 504, each including a plurality of information bits (systematic bits), corresponding to a portion of the packet.

Each of the code blocks 504 may then be encoded by a block encoder 506 based on a selected modulation and coding scheme (MCS) for the transport block 502 to produce M encoded code blocks 508, each corresponding to a respective one of the code blocks 504. Each encoded code block 508 includes systematic (information) bits 510 and parity (redundancy) bits 512. For example, each of the code blocks 504 may have a length of K information bits 510. The block encoder 506 may then mathematically add redundancy (e.g., parity bits 512) to each code block 504, resulting in codewords or encoded code blocks 508, each having a length of N, where N>K. Here, the code rate R is the ratio between the code block length and the encoded code block length: i.e., R=K/N. Thus, with block codes, the information bits are transmitted together with the parity bits. The block encoder 506 may, in some examples, be an LDPC encoder or a polar encoder.

Further processing (e.g., modulation, tone mapping, etc.) may then be performed on the encoded code blocks 508 by processing block 514 before being input to a digital-to-analog converter (DAC)/radio frequency (RF) block 516 for analog conversion and up-conversion of the analog signal to RF. For example, the processing block 514 may modulate the encoded code blocks 508 using a modulation scheme of the selected MCS for the transport block 502. The RF signal may then be transmitted via an antenna 518 (or antenna array) to a receiving device.

When one or more CBs 504 are not successfully received by the receiving device (e.g., the CBs 504 do not pass CRC), the receiving device may report a NACK for the entire transport block 502. The transmitting device 500 may then retransmit the entire transport block 502 using a HARQ process. For higher HARQ efficiency, when a transport block 502 contains multiple CBs 504, the CBs 504 may be grouped into code block groups (CBGs).

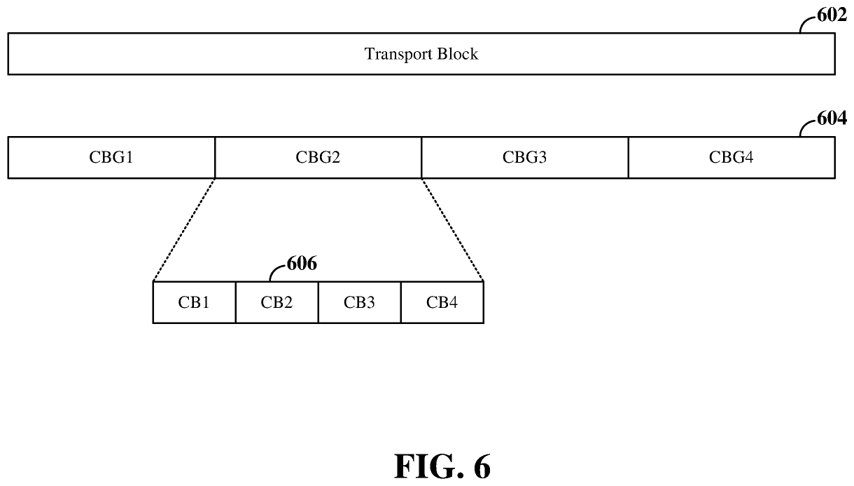

FIG. 6 is a diagram illustrating an example of a transport block 602 including code block groups (CBGs) 604 according to some aspects. Each CBG 604 includes two or more CBs 606. In the example shown in FIG. 6, the transport block 602 is divided into four CBGs 604 (e.g., CBG1, CBG2, CBG3, and CBG4). In addition, each CBG 604 includes four CBs 606 (e.g., CB1, CB2, CB3, and CB4). A receiving device can transmit an ACK or NACK for each CBG 604. For example, when a particular CB 606 (e.g., CB2) is not successfully received by a receiving device (e.g., does not pass CRC), the receiving device can transmit a NACK for the CBG 604 (e.g., CBG2) including that particular CB 606. The transmitting device can then retransmit the CBGs 604 for which a NACK is received instead of retransmitting the entire transport block 602.

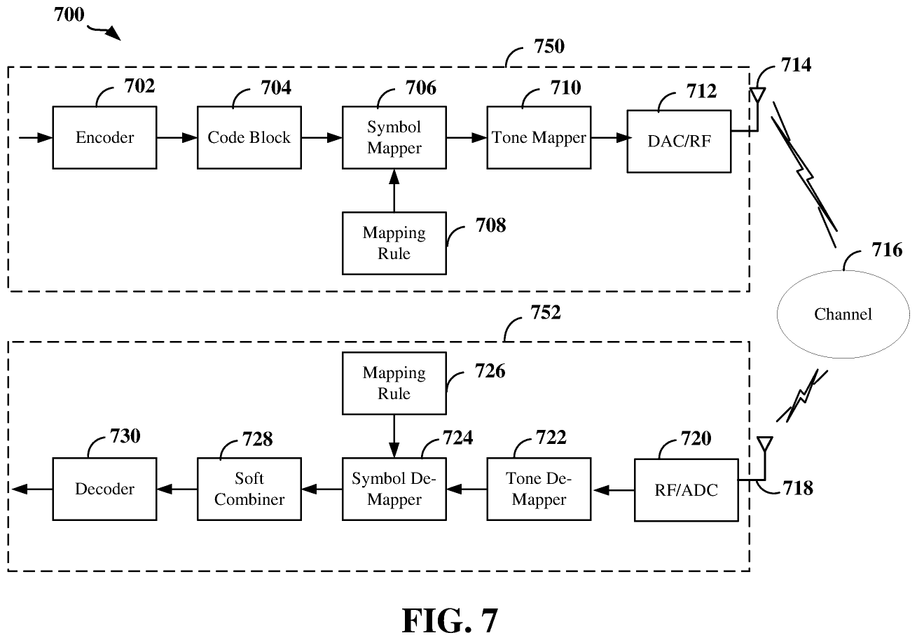

FIG. 7 is a schematic illustration of a wireless communication system 700 as may be implemented between a transmitter 750 and a receiver 752 within a radio access network, such as the RAN 100 shown in FIG. 1. In some examples, the transmitter 750 or receiver may correspond to any of the base stations or UEs shown in FIGS. 1 and/or 2.

The transmitter 750 may receive an information block (e.g., a transport block, such as a packet) including a plurality of information bits for transmission to the receiver 752. An encoder 702 may be configured to encode the information block using any suitable encoding scheme to produce a code block 704 (e.g., an encoded code block) including a plurality of encoded bits. As described above, the encoded bits may include both systematic bits (e.g., original information bits) and parity bits (e.g., redundancy bits) or only parity bits, depending upon the encoding scheme utilized. In addition, the code block 704 may be representative of a plurality of encoded code blocks based on segmentation of the transport block (e.g., information block).

The code block 704 may be input to a symbol mapper 706. The symbol mapper 706 may be configured to digitally modulate the code block 704 by mapping the encoded bits to symbols to produce modulated symbols. The symbol mapper 706 may utilize any suitable type of modulation, including but not limited to BPSK, QPSK, 16-QAM, 64-QAM, 256-QAM, or any other M-QAM. For example, when using 64-QAM, the symbol mapper 706 may map six encoded bits to each symbol. As another example, when using 256-QAM, the symbol mapper 706 may map eight bits to each symbol. The number of bits mapped to each symbol may be equal to log₂M, where M indicates the modulation order (e.g., the number of finite states of the symbol). The symbol mapper 706 may further map the encoded bits to specific bit locations within the symbol. For example, for an M-QAM symbol, the symbol mapper 706 may map the encoded bits to the symbol in the following bit order [0, 1, 2, . . . , log₂(M−2), log₂(M−1)] to map the encoded bits to modulated symbols using a particular modulation scheme (e.g., QPSK, 16 QAM, 64 QAM, etc.). The modulated symbols are then mapped onto the assigned sub-carriers or tones by a tone mapper 710 to produce modulated sub-carriers. In some examples, the assigned sub-carriers form a set of contiguous tones.

The modulated sub-carriers may then be converted to the time domain (not shown) to produce output symbols (e.g., OFDM symbols) that may then be input to a digital-to-analog converter (DAC)/radio frequency (RF) block 712 for analog conversion and up-conversion of the respective analog signals to RF. The RF signal may then be transmitted via an antenna 714 (or antenna array).

The RF signal traverses a wireless channel 716 to the receiver 752, where the RF signal is received by an antenna 718, down-converted to baseband, and then converted to a digital signal by an RF/analog-to-digital converter (ADC) block 720. The digital signal is then transformed to a frequency domain signal (not shown), and sub-carrier de-mapping may then be performed by a tone de-mapper 722 to produce modulated symbols. The modulated symbols may then be input to a symbol de-mapper 724 to demodulate the modulated symbols and recover the encoded bits (code block). A decoder 730 may then decode the encoded bits to produce the original bit stream. If the decoder 730 is unable to decode the encoded bits and transmits a NACK, a second (retransmitted) code block 704 may be generated by the transmitter 750.

At the receiver 752, the symbol de-mapper 724 may utilize a symbol mapping rule 726, which may correspond to the symbol mapping rule 708 utilized in the transmitter 750, to identify corresponding/redundant encoded bits in the modulated symbols of the original and retransmitted code blocks and input the corresponding/redundant bits to a soft combiner 728, where the corresponding/redundant bits from the retransmission may be combined with the original transmission before decoding by the decoder 730 to increase the probability of correct reception of each bit.

The symbol de-mapper 724 may further utilize a type of demodulator to demodulate the modulated symbols. Examples of demodulator types may include, but are not limited to, a minimum-mean-squared-error (MMSE) demodulator or a maximum likelihood (ML) demodulator. In some examples, the receiver 752 may be a UE with a capability to dynamically switch between demodulators. For example, the receiver 752 may utilize a first demodulator type (e.g., MMSE) in demodulating a first packet at a first time and a second demodulator type (e.g., ML) in demodulating a second packet at a second time. However, the transmitter (e.g., a base station) may be unaware of the specific demodulator type utilized by the UE in demodulating each packet, which may result in a higher number of retransmissions of a packet.

Therefore, to reduce the number of retransmissions, various aspects enable the UE (e.g., receiver 752) to report the demodulator type utilized by the UE in demodulating an initial transmission of a packet to the base station (e.g., transmitter 750). The demodulator type report may be sent together with a NACK in response to failure of the UE to decode the initial packet transmission.

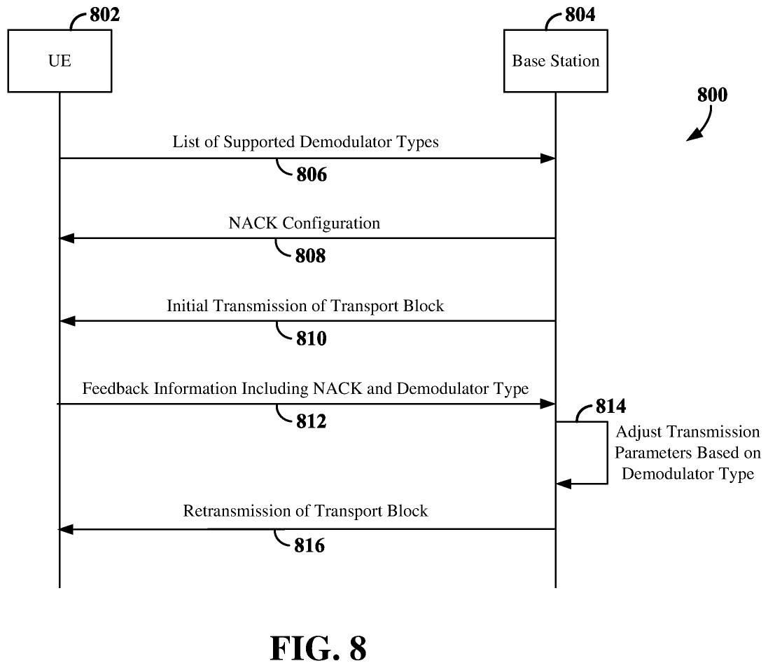

FIG. 8 is a diagram illustrating exemplary signaling for reporting a demodulator type from a UE 802 to a RAN node (e.g., a base station) 804 according to some aspects. The base station 804 may correspond to any of the base stations (e.g., gNBs) or other scheduling entities illustrated in any of FIGS. 1, 2, 4, and/or 7. In addition, the UE 802 may correspond to any of the UEs or other scheduled entities illustrated in any of FIGS. 1, 2, 4, and/or 7.

At 806, the UE 802 transmits a list of demodulator types supported by the UE 802 to the base station 804. In some examples, the list of demodulator types may be transmitted within a UE capability information message that further indicates that the UE is capable of dynamically switching between demodulators. The UE capability information message is an RRC message sent by the UE 802 to the base station 804 during initial registration. In other examples, the list of demodulator types may be transmitted within a PUSCH prior to RRC configuration of the UE 802.

At 808, based on the list of supported demodulator types, the base station 804 may optionally configure the size of a NACK field. The NACK field size may be configured per transport block and/or per code block group (CBG). For example, the NACK field per transport block or per CBG may include one, two, or three additional bits to indicate the demodulator type used by the UE 802. The base station 804 may then transmit the NACK configuration to the UE 802. For example, the NACK configuration may be transmitted via DCI, a medium access control (MAC) control element (MAC-CE), or RRC message. In other examples, the NACK field size may be pre-configured or set in accordance with one or more 3GPP standards or specifications.

At 810, the base station 804 transmits an initial transmission of a transport block (e.g., a packet). The initial transmission may correspond, for example, to an initial redundancy version (e.g., RV0). In some examples, the transport block includes a plurality of code blocks (e.g., encoded code blocks) that may be grouped into CBGs.

If the initial transmission is not properly received (e.g., does not pass CRC), at 812, the UE 802 transmits feedback information including a NACK to the base station 804. In addition, in various aspects of the disclosure, the feedback information further includes an indicator of a demodulator type utilized by the UE 802 in demodulating the initial transmission of the transport block. The NACK and demodulator type indicator may be transmitted in a NACK field, configured as indicated at 808. The NACK field may be carried, for example, within PUCCH format 1. The NACK field may include acknowledgement information (e.g., NACK) and the demodulator type indicator. In some examples, a single NACK field may be transmitted for the entire transport block. In other examples, respective NACK fields may be transmitted for each CBG for which CRC did not pass. In this example, each CBG NACK field may include a respective demodulator type indicator. For example, the UE 802 may utilize a respective demodulator type for demodulation of each of the CBGs of the transport block and may indicate the respective demodulator type utilized for each of the CBGs for which the acknowledgement information includes a NACK.

At 814, the base station 804 may adjust one or more transmission parameters for a retransmission of the transport block to attempt to reduce the number of retransmissions. In some examples, the base station 804 may adjust a precoding parameter based on the demodulator type and the NACK. For example, if the UE 802 utilized a relatively less complex demodulator, such as a MMSE demodulator, the base station 804 may adjust the precoding to optimize reception by the UE. In an example, the adjusted precoding may result in the equivalent channel being diagonal (e.g., singular value decomposition (SVD) precoding). For more complex demodulators, such as ML demodulators, the base station 804 may not adjust the precoding.

In some examples, the base station 804 may adjust a redundancy version (RV) of the retransmission of the transport block based on the demodulator type and the NACK. For example, the base station 804 may select RV2 or other RV for the first retransmission of the transport block based on the demodulator type.

In some examples, the base station 804 may adjust a modulation order of the retransmission of the transport block based on the demodulator type and the NACK. The modulation order may be represented by a parameter Qₘ and the relationship between the MCS value and Qₘ may be defined in various tables within 3GPP standards or specifications. An example of an MCS index table from 3GPP TS 38.214 v16.6.0 (2021-06), section 5.1.3.1 showing the relationship between Qₘ and the MCS value for PDSCH transmissions is shown below as Table 1.

TABLE 1

| MCS Index | Modulation Order | Target code | Spectral |
|---|---|---|---|
| I_{MCS} | Qₘ | Rate R × [1024] | efficiency |
| 0 | 2 | 120 | 0.2344 |
| 1 | 2 | 157 | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 438 | 2.5664 |
| 18 | 6 | 466 | 2.7305 |
| 19 | 6 | 517 | 3.0293 |
| 20 | 6 | 567 | 3.3223 |
| 21 | 6 | 616 | 3.6094 |
| 22 | 6 | 666 | 3.9023 |
| 23 | 6 | 719 | 4.2129 |
| 24 | 6 | 772 | 4.5234 |
| 25 | 6 | 822 | 4.8164 |
| 26 | 6 | 873 | 5.1152 |
| 27 | 6 | 910 | 5.3320 |
| 28 | 6 | 948 | 5.5547 |

| | | |
|---|---|---|
| 29 | 2 | reserved |
| 30 | 4 | reserved |
| 31 | 6 | reserved |

In some examples, the base station 804 may utilize one of the reserved fields in the above MCS index table (Table 1) or other suitable MCS index table to select a modulation order for the retransmission, while preserving the code-related retransmission definitions. In some examples, the retransmission may further utilize the same code rate or a different code rate than that used for the initial transmission (RV0).

At 816, the base station 804 transmits are transmission of the transport block based on the adjusted transmission parameters. For example, the base station 804 may transmit the retransmission based on one or more of a precoding parameter, a redundancy version, or a modulation order selected based on the demodulator type. In some examples, the UE 802 may transmit additional feedback information to the base station 804 indicating whether or not the UE 802 is able to decode the transport block based further on the retransmission (e.g., using HARQ-IR or HARQ-CC). In examples in which the UE 802 is unable to decode to the transport block further based on the retransmission, the additional feedback information may include the NACK, along with the demodulator type indicator utilized by the UE 802 in demodulating the transport block.

In some examples, the base station 804 may further utilize the demodulator type to reduce an outer-loop link adaptation convergence period. In some examples, the base station 804 may utilize an outer-loop link adaptation process in which the MCS may be modified based on the HARQ feedback information (e.g., NACK) and the demodulator type. By utilizing the demodulator type to adjust the outer-loop link adaptation process, the link adaptation convergence period may be reduced, thus improving the block error rate (BLER) of subsequent transmissions.

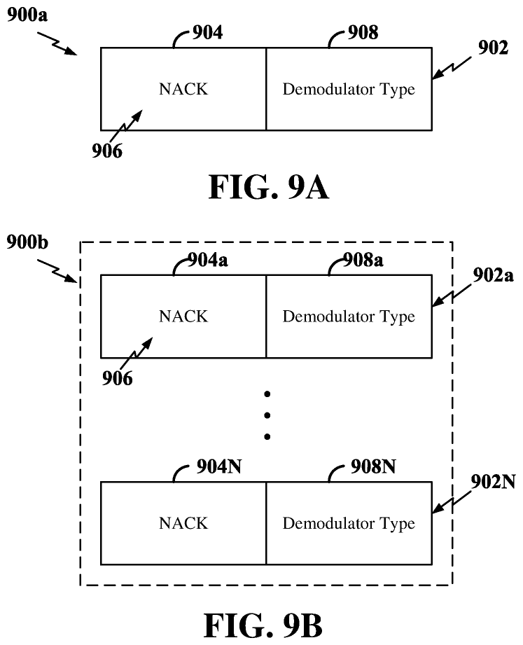

FIGS. 9A and 9B are diagrams illustrating exemplary HARQ feedback information 900a and 900b according to some aspects. In the example shown in FIG. 9A, the feedback information 900a includes a single NACK field 902. The NACK field 902 includes acknowledgement information 904 for a transmission of a transport block (e.g., the initial transmission or a retransmission of the transport block). The acknowledgement information 904 includes a NACK 906 indicating that one or more CBs of the transport block were not able to be decoded properly (e.g., did not pass CRC). The feedback information 900a further includes an indicator 908 of a demodulator type utilized by the UE in demodulating the initial transmission of the transport block. In some examples, the acknowledgement information 904 includes a single bit indicating the NACK 906 and the demodulator type indicator 908 includes between one and three bits indicating the demodulator type.

In the example shown in FIG. 9B, the feedback information 900b includes a respective NACK field 902a . . . 902N for each of a plurality of CBGs of the transport block that were unable to be properly decoded. Each NACK field 902a . . . 902N includes respective acknowledgement information 904a . . . 904N indicating a NACK 906 of the corresponding CBG and respective demodulator type indicators 908a . . . 908N indicating the demodulator type utilized in demodulating the corresponding CBG. In some examples, the demodulator type indicators 908a . . . 908N may indicate the same demodulator type used for all of the CBGs. In other examples, the demodulator type indicators 908a . . . 908N may indicate that at least two of the CBGs utilized a different demodulator type for demodulation thereof.

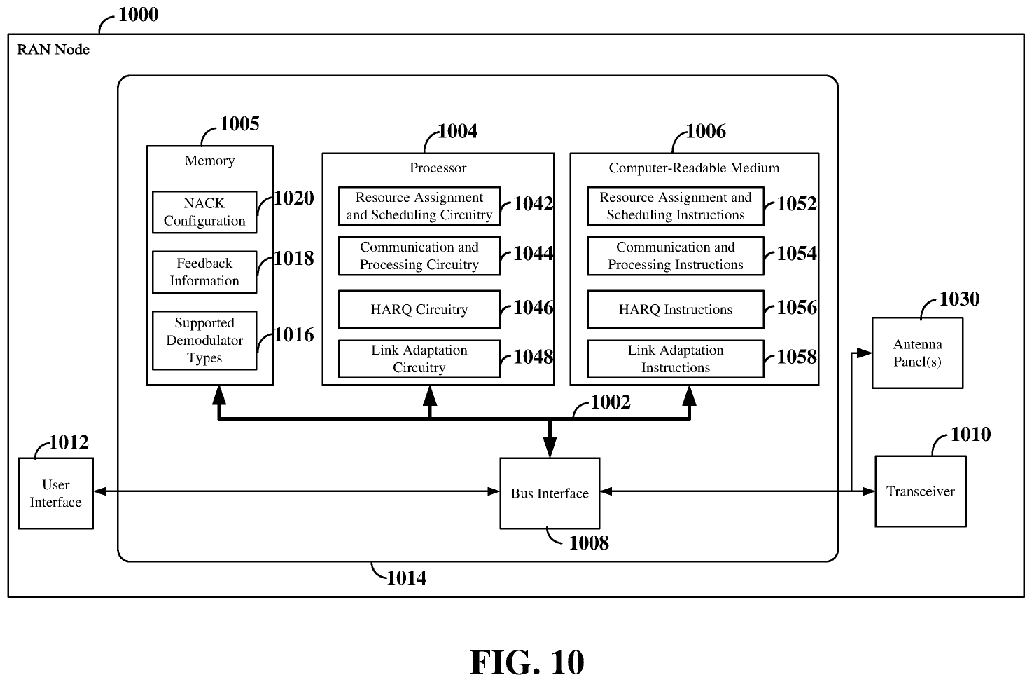

FIG. 10 is a block diagram illustrating an example of a hardware implementation for a radio access network (RAN) node 1000 employing a processing system 1014. For example, the RAN node 1000 may be any of the base stations (e.g., gNBs) or other scheduling entities illustrated in any one or more of FIGS. 1, 2, 4, 7, and/or 8.

The RAN node 1000 may be implemented with a processing system 1014 that includes one or more processors 1004. Examples of processors 1004 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the RAN node 1000 may be configured to perform any one or more of the functions described herein. That is, the processor 1004, as utilized in a RAN node 1000, may be used to implement any one or more of the processes and procedures described herein and illustrated in FIGS. 8 and/or 11.

The processor 1004 may in some instances be implemented via a baseband or modem chip and in other implementations, the processor 1004 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1014 may be implemented with a bus architecture, represented generally by the bus 1002. The bus 1002 may include any number of interconnecting buses and bridges depending on the specific application of the processing system 1014 and the overall design constraints. The bus 1002 communicatively couples together various circuits including one or more processors (represented generally by the processor 1004), a memory 1005, and computer-readable media (represented generally by the computer-readable medium 1006). The bus 1002 may also link various other circuits such as timing sources, peripherals, voltage regulators, and power management circuits, which are well known in the art, and therefore, will not be described any further.

A bus interface 1008 provides an interface between the bus 1002, a transceiver 1010, and one or more antenna panels 1030. The transceiver 1010 and antenna panels 1030 provide a communication interface or a means for communicating with various other apparatus over a transmission medium (e.g., air interface). Depending upon the nature of the apparatus, a user interface 1012 (e.g., keypad, display, speaker, microphone, joystick) may also be provided. Of course, such a user interface 1012 is optional, and may be omitted in some examples.

The processor 1004 is responsible for managing the bus 1002 and general processing, including the execution of software stored on the computer-readable medium 1006. The software, when executed by the processor 1004, causes the processing system 1014 to perform the various functions described below for any particular apparatus. The computer-readable medium 1006 and the memory 1005 may also be used for storing data that is manipulated by the processor 1004 when executing software. For example, the memory 1005 may store one or more of supported demodulator types 1016, feedback information 1018, or a NACK configuration 1020 that may be used by the processor 1004 in receiving a demodulator type with a NACK from a UE and adjusting one or more transmission parameters for a retransmission of a transport block based on the demodulator type and the NACK.

One or more processors 1004 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1006.

The computer-readable medium 1006 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1006 may reside in the processing system 1014, external to the processing system 1014, or distributed across multiple entities including the processing system 1014. The computer-readable medium 1006 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In some aspects of the disclosure, the processor 1004 may include circuitry configured for various functions. For example, the processor 1004 may include resource assignment and scheduling circuitry 1042, configured to generate, schedule, and modify a resource assignment or grant of time-frequency resources (e.g., a set of one or more resource elements). For example, the resource assignment and scheduling circuitry 1042 may schedule time-frequency resources within a plurality of time division duplex (TDD) and/or frequency division duplex (FDD) subframes, slots, and/or mini-slots to carry user data traffic and/or control information to and/or from multiple UEs.

In some examples, the resource assignment and scheduling circuitry 1042 may be configured to schedule resources for the transmission of a list of supported demodulator types 1016 from a UE to the RAN node 1000. In some examples, the supported demodulator types 1016 may be transmitted via, for example, a PUSCH or RRC message. In some examples, the resource assignment and scheduling circuitry 1042 may be configured to schedule resources for the transmission of an initial transmission of a transport block (e.g., via a PDSCH) to a UE. In addition, the resource assignment and scheduling circuitry 1042 may schedule resources for the transmission of feedback information 1018 (e.g., HARQ ACK/NACK) from the UE to the RAN node 1000. The feedback information may include, for example, acknowledgement information (e.g., HARQ ACK/NACK), and may further include an indicator of a demodulator type utilized by the UE in demodulating the initial transmission of the transport block in examples in which the acknowledgement information includes a NACK. In some examples, the feedback information may include respective acknowledgement information for each of a plurality of CBGs of the transport block. In this example, the feedback information may further include a respective indicator of the demodulator type utilized to demodulate each CBG for which a NACK is sent. In addition, the resource assignment and scheduling circuitry 1042 may be configured to schedule resources for a retransmission of the transport block. The resource assignment and scheduling circuitry 1042 may further be configured to execute resource assignment and scheduling instructions (software) 1052 stored on the computer-readable medium 1006 to implement one or more of the functions described herein.

The processor 1004 may further include communication and processing circuitry 1044, configured to communicate with one or more UEs via Uu links. In some examples, the communication and processing circuitry 1044 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1044 may include one or more transmit/receive chains.

In some implementations where the communication involves receiving information, the communication and processing circuitry 1044 may obtain information from a component of the RAN node 1000 (e.g., from the transceiver 1010 that receives the information via radio frequency signaling or some other type of signaling suitable for the applicable communication medium), process (e.g., decode) the information, and output the processed information. For example, the communication and processing circuitry 1044 may output the information to another component of the processor 1004, to the memory 1005, or to the bus interface 1008. In some examples, the communication and processing circuitry 1044 may receive one or more of signals, messages, other information, or any combination thereof. In some examples, the communication and processing circuitry 1044 may receive information via one or more channels. In some examples, the communication and processing circuitry 1044 may include functionality for a means for receiving. In some examples, the communication and processing circuitry 1044 may include functionality for a means for processing, including a means for demodulating, a means for decoding, etc.

In some implementations where the communication involves sending (e.g., transmitting) information, the communication and processing circuitry 1044 may obtain information (e.g., from another component of the processor 1004, the memory 1005, or the bus interface 1008), process (e.g., modulate, encode, etc.) the information, and output the processed information. For example, the communication and processing circuitry 1044 may output the information to the transceiver 1010 (e.g., that transmits the information via radio frequency signaling or some other type of signaling suitable for the applicable communication medium). In some examples, the communication and processing circuitry 1044 may send one or more of signals, messages, other information, or any combination thereof. In some examples, the communication and processing circuitry 1044 may send information via one or more channels. In some examples, the communication and processing circuitry 1044 may include functionality for a means for sending (e.g., a means for transmitting). In some examples, the communication and processing circuitry 1044 may include functionality for a means for generating, including a means for modulating, a means for encoding, etc.

In some examples, the communication and processing circuitry 1044 may be configured to receive the list of supported demodulator types 1016 from the UE. The communication and processing circuitry 1044 may further be configured to configure a NACK configuration 1020 for the UE. The NACK configuration 1020 indicates the size of a NACK field for the UE. The NACK field size may be configured per transport block and/or per code block group (CBG). For example, the NACK field per transport block or per CBG may include one, two, or three additional bits to indicate the demodulator type used by the UE. The communication and processing circuitry 1044 may further be configured to transmit the NACK configuration 1020 to the UE via, for example, DCI, a MAC-CE, or an RRC message. In some examples, the NACK configuration 1020 may be pre-configured on the RAN node 1000 (e.g., by the OEM based on one or more 3GPP standards or specifications).

In some examples, the communication and processing circuitry 1044 may be configured to transmit the initial transmission of the transport block to the UE. In addition, the communication and processing circuitry 1044 may further be configured to receive feedback information 1018 from the UE. The feedback information 1018 may include, for example, acknowledgement information (e.g., HARQ ACK/NACK). In examples in which the acknowledgement information includes a NACK, the feedback information 1018 may further include a demodulator type indicator indicating the demodulator type utilized by the UE in demodulating the initial transmission. In some examples, the feedback information may include respective acknowledgement information for each of a plurality of CBGs and a respective demodulator indicator type for each CBG for which the acknowledgement information includes a NACK. The communication and processing circuitry 1044 may further be configured to transmit the retransmission of the transport block. The communication and processing circuitry 1044 may further be configured to execute communication and processing instructions (software) 1054 stored in the computer-readable medium 1006 to implement one or more of the functions described herein.

The processor 1004 may further include HARQ circuitry 1046, configured to adjust one or more transmission parameters of a retransmission of the transport block based on the demodulator type and the NACK indicated in the feedback information 1018. For example, the HARQ circuitry 1046 may be configured to adjust one or more of a precoding parameter, a redundancy version, or a modulation order selected based on the demodulator type. In some examples, the HARQ circuitry 1046 may be configured to adjust one or more transmission parameters for each CBG of the transport block for which a NACK is received based on the demodulator type indicated for that CBG in the feedback information 1018. The HARQ circuitry 1046 may further be configured to execute a HARQ-CC or HARQ-IR algorithm to generate the retransmission of the transport block using the one or more adjusted transmission parameters for transmission to the UE via the communication and processing circuitry 1044. The HARQ circuitry 1046 may further be configured to execute HARQ instructions (software) 1056 stored in the computer-readable medium 1006 to implement one or more of the functions described herein.

The processor 1004 may further include link adaptation circuitry 1048, configured to perform an outer-loop link adaptation based on the demodulator type indicated in the feedback information 1018. The link adaptation circuitry 1048 may further be configured to execute link adaptation instructions (software) 1058 stored in the computer-readable medium 1006 to implement one or more of the functions described herein.

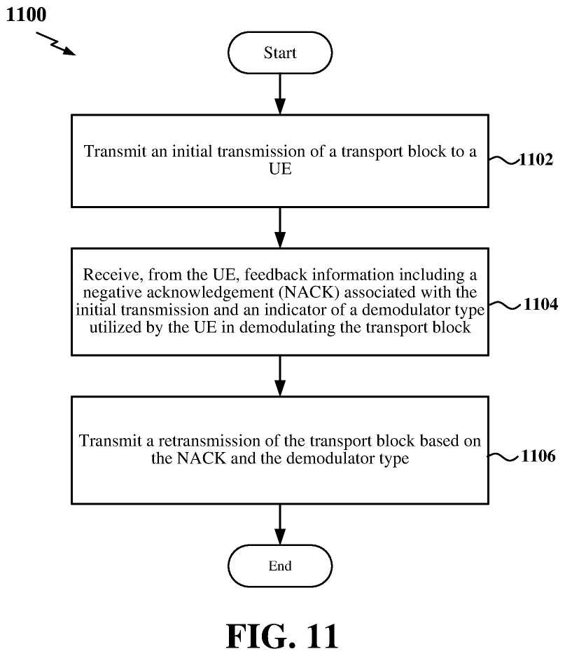

FIG. 11 is a flow chart illustrating an exemplary process 1100 for reporting a demodulator type with a negative acknowledgement (NACK) according to some aspects. As described below, some or all illustrated features may be omitted in a particular implementation within the scope of the present disclosure, and some illustrated features may not be required for implementation of all examples. In some examples, the process 1100 may be carried out by the RAN node 1000 illustrated in FIG. 10. In some examples, the process 1100 may be carried out by any suitable apparatus or means for carrying out the functions or algorithms described below.

At block 1102, the RAN node may transmit an initial transmission of a transport block to a user equipment (UE). For example, the communication and processing circuitry 1044, together with the transceiver 1010, and antenna panel(s) 1030, shown and described above in connection with FIG. 10 may provide a means to transmit the initial transmission of the transport block.

At block 1104, the RAN node may receive, from the UE, feedback information including a negative acknowledgement (NACK) associated with the initial transmission and an indicator of a demodulator type utilized by the UE in demodulating the transport block. In some examples, the feedback information includes respective acknowledgement information for each of a plurality of code block groups (CGBs) of the transport block. In this example, the feedback information further includes a respective indicator of a respective demodulator type utilized for each of the plurality of CBGs for which the acknowledgement information comprises a respective NACK.

In some examples, the RAN node may further receive a list of demodulator types supported by the UE. The list of demodulator types includes the demodulator type utilized by the UE in demodulating the transport block. For example, the RAN node may receive the list of demodulator types supported by the UE within a UE capability information message. As another example, the RAN node may receive the list of demodulator types supported by the UE within a physical uplink shared channel (PUSCH) prior to radio resource control (RRC) configuration of the UE. For example, the communication and processing circuitry 1044, together with the HARQ circuitry 1046, transceiver 1010, and antenna panel(s) 1030, shown and described above in connection with FIG. 10 may provide a means to receive the feedback information including the NACK and demodulator type indicator from the UE.

At block 1106, the RAN node may transmit a retransmission of the transport block based on the NACK and the demodulator type. In some examples, the RAN node may adjust a precoding parameter based on the demodulator type and the NACK. In some examples, the RAN node may adjust a redundancy version for the retransmission of the transport block based on the demodulator type and the NACK. In some examples, the RAN node may adjust a modulation order for the retransmission of the transport block based on the demodulator type and the NACK. In some examples, the RAN node may perform an outer-loop link adaptation based on the demodulator type and the NACK. For example, the communication and processing circuitry 1044, together with the HARQ circuitry 1046, transceiver 1010, and antenna panel(s) 1030, shown and described above in connection with FIG. 10 may provide a means to transmit the retransmission of the transport block based on the NACK and demodulator type.

In one configuration, the RAN node 1000 includes means for performing the various functions and processes described in relation to FIG. 11. In one aspect, the aforementioned means may be the processor 1004 shown in FIG. 10 configured to perform the functions recited by the aforementioned means. In another aspect, the aforementioned means may be a circuit or any apparatus configured to perform the functions recited by the aforementioned means.

Of course, in the above examples, the circuitry included in the processor 1004 is merely provided as an example, and other means for carrying out the described functions may be included within various aspects of the present disclosure, including but not limited to the instructions stored in the computer-readable storage medium 1006, or any other suitable apparatus or means described in any one of the FIGS. 1, 2, 4, and/or 7, and utilizing, for example, the processes and/or algorithms described herein in relation to FIGS. 8 and/or 11.

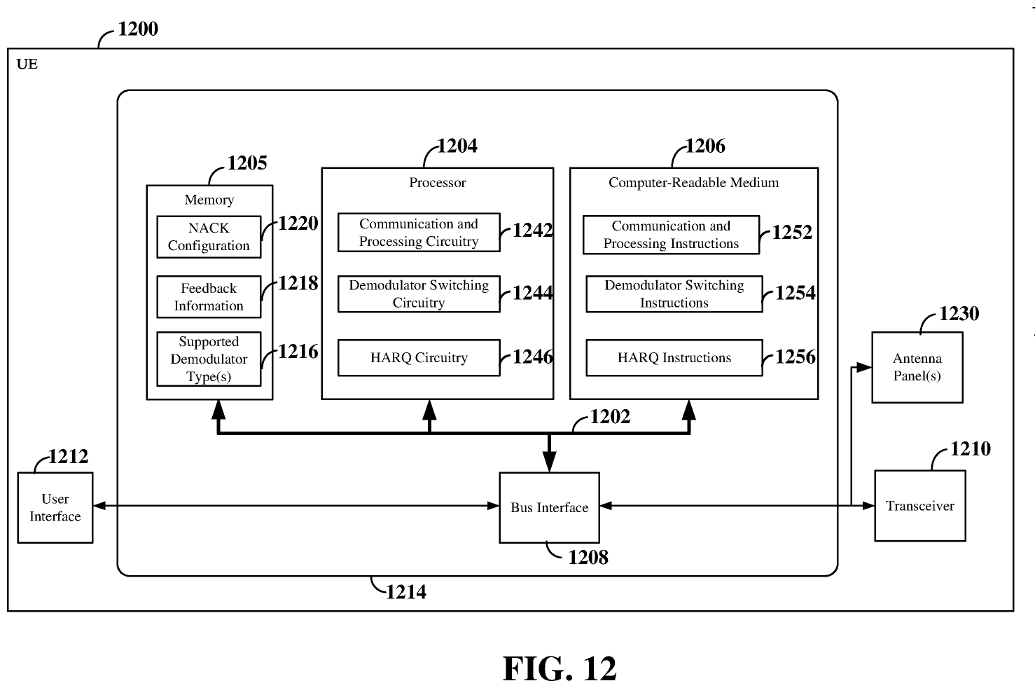

FIG. 12 is a block diagram illustrating an example of a hardware implementation for a user equipment (UE) 1200 employing a processing system 1214. For example, the UE 1200 may be any of the UEs, wireless communication devices, or other scheduled entities illustrated in any one or more of FIGS. 1, 2, 4, 7, and/or 8.

In accordance with various aspects of the disclosure, an element, or any portion of an element, or any combination of elements may be implemented with a processing system 1214 that includes one or more processors 1204. The processing system 1214 may be substantially the same as the processing system 1014 illustrated in FIG. 10, including a bus interface 1208, a bus 1202, memory 1205, a processor 1204, and a computer-readable medium 1206. Furthermore, the UE 1200 may include an optional user interface 1212, a transceiver 1210, and one or more antenna panels 1230 substantially similar to those described above in FIG. 10. That is, the processor 1204, as utilized in a UE 1200, may be used to implement any one or more of the processes described below. The computer-readable medium 1206 and the memory 1205 may also be used for storing data that is manipulated by the processor 1204 when executing software. For example, the memory 1205 may store one or more of supported demodulator type(s) 1216, feedback information 1218, or a NACK configuration 1220 that may be used by the processor 1204 in reporting the demodulator type together with the NACK to a radio access network (RAN) node (e.g., a base station, such as a gNB).

In some aspects of the disclosure, the processor 1204 may include circuitry configured for various functions. For example, the processor 1204 may include communication and processing circuitry 1242, configured to communicate with a RAN node (e.g., a base station), such as a gNB or eNB via a Uu link. In some examples, the communication and processing circuitry 1242 may include one or more hardware components that provide the physical structure that performs processes related to wireless communication (e.g., signal reception and/or signal transmission) and signal processing (e.g., processing a received signal and/or processing a signal for transmission).

In some implementations where the communication involves receiving information, the communication and processing circuitry 1242 may obtain information from a component of the UE 1200 (e.g., from the transceiver 1210 that receives the information via radio frequency signaling or some other type of signaling suitable for the applicable communication medium), process (e.g., decode) the information, and output the processed information. For example, the communication and processing circuitry 1242 may output the information to another component of the processor 1204, to the memory 1205, or to the bus interface 1208. In some examples, the communication and processing circuitry 1242 may receive one or more of signals, messages, other information, or any combination thereof. In some examples, the communication and processing circuitry 1242 may receive information via one or more channels. In some examples, the communication and processing circuitry 1242 may include functionality for a means for receiving. In some examples, the communication and processing circuitry 1242 may include functionality for a means for processing, including a means for demodulating, a means for decoding, etc.

In some implementations where the communication involves sending (e.g., transmitting) information, the communication and processing circuitry 1242 may obtain information (e.g., from another component of the processor 1204, the memory 1205, or the bus interface 1208), process (e.g., modulate, encode, etc.) the information, and output the processed information. For example, the communication and processing circuitry 1242 may output the information to the transceiver 1210 (e.g., that transmits the information via radio frequency signaling or some other type of signaling suitable for the applicable communication medium). In some examples, the communication and processing circuitry 1242 may send one or more of signals, messages, other information, or any combination thereof. In some examples, the communication and processing circuitry 1242 may send information via one or more channels. In some examples, the communication and processing circuitry 1242 may include functionality for a means for sending (e.g., a means for transmitting). In some examples, the communication and processing circuitry 1242 may include functionality for a means for generating, including a means for modulating, a means for encoding, etc.

In some examples, the communication and processing circuitry 1242 may be configured to transmit the list of supported demodulator types 1216 to the UE. The communication and processing circuitry 1242 may further be configured to receive the NACK configuration 1220 from the RAN node. The NACK configuration 1220 indicates the size of a NACK field for the UE 1200. The NACK field size may be configured per transport block and/or per code block group (CBG). For example, the NACK field per transport block or per CBG may include one, two, or three additional bits to indicate the demodulator type used by the UE 1200. In some examples, the NACK configuration 1220 may be received via DCI, a MAC-CE, or an RRC message. In other examples, the NACK configuration 1220 may be pre-configured on the UE (e.g., by the OEM based on one or more 3GPP standards or specifications).

In some examples, the communication and processing circuitry 1242 may be configured to receive an initial transmission of a transport block from the RAN node. In addition, the communication and processing circuitry 1242 may further be configured to transmit feedback information 1218 to the RAN node. The feedback information 1218 may include, for example, acknowledgement information (e.g., HARQ ACK/NACK). In examples in which the acknowledgement information includes a NACK, the feedback information 1218 may further include a demodulator type indicator indicating the demodulator type utilized by the UE in demodulating the initial transmission. In some examples, the feedback information may include respective acknowledgement information for each of a plurality of CBGs and a respective demodulator indicator type for each CBG for which the acknowledgement information includes a NACK. The communication and processing circuitry 1242 may further be configured to transmit a retransmission of the transport block. The communication and processing circuitry 1242 may further be configured to execute communication and processing instructions (software) 1252 stored in the computer-readable medium 1206 to implement one or more of the functions described herein.

The processor 1204 may further include demodulator switching circuitry 1244, configured to dynamically switch between the supported demodulator types 1216 for use by the communication and processing circuitry 1242 in demodulating received transport blocks. The demodulator switching circuitry 1244 may further be configured to select different demodulator types for demodulation of different CBGs of the same transport block. The demodulator switching circuitry 1244 may further be configured to execute demodulator switching instructions (software) 1254 stored in the computer-readable medium 1206 to implement one or more of the functions described herein.

The processor 1204 may further include HARQ circuitry 1246, configured to process the received initial transmission of the transport block and generate the feedback information 1218 for transmission to the RAN node via the communication and processing circuitry 1242. For example, if decoding of the received initial transmission of the transport block fails (e.g., does not pass CRC), the HARQ circuitry 1246 may generate the feedback information 1218 including a NACK. In addition, the HARQ circuitry 1246 may operate together with the demodulator switching circuitry 1244 to identify the demodulator type utilized in processing the initial transmission of the transport block and to include an indicator of the demodulator type in the feedback information 1218 carrying the NACK. In some examples, the HARQ circuitry 1246 may be configured to generate the feedback information 1218 including a respective NACK for each CBG that fails to be decoded, along with a respective demodulator type indicator for each CBG for which a NACK is generated.

The HARQ circuitry 1246 may further be configured to process the received retransmission of the transport block and to attempt to decode the transport block based on the initial transmission and the retransmission. In some examples, one or more transmission parameters of the retransmission of the transport block may be adjusted by the RAN node based on the demodulator type to improve the likelihood of the transport block being decoded by the HARQ circuitry 1246. For example, one or more of a precoding parameter, redundancy version, or modulation order of the retransmission of the transport block may be adjusted by the RAN node. The HARQ circuitry 1246 may further be configured to execute HARQ instructions (software) 1256 stored in the computer-readable medium 1206 to implement one or more of the functions described herein.

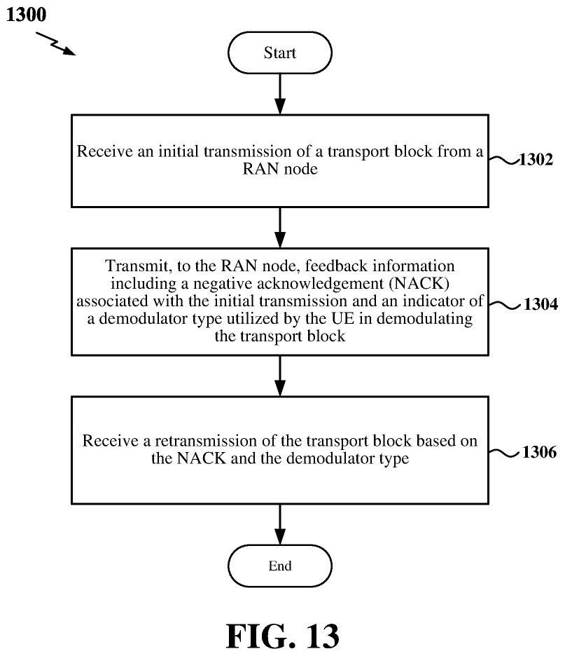

FIG. 13 is a flow chart illustrating another exemplary process 1300 for reporting a demodulator type with a negative acknowledgement (NACK) according to some aspects. As described below, some or all illustrated features may be omitted in a particular implementation within the scope of the present disclosure, and some illustrated features may not be required for implementation of all examples. In some examples, the process 1300 may be carried out by the UE 1200 illustrated in FIG. 12. In some examples, the process 1300 may be carried out by any suitable apparatus or means for carrying out the functions or algorithms described below.

At block 1302, a UE may receive an initial transmission of a transport block from a radio access network (RAN) node. For example, the communication and processing circuitry 1242, together with the transceiver 1210, and antenna panel(s) 1230, shown and described above in connection with FIG. 12 may provide a means to receive the initial transmission of the transport block.

At block 1304, the UE may transmit, to the RAN node, feedback information including a negative acknowledgement (NACK) associated with the initial transmission and an indicator of a demodulator type utilized by the UE in demodulating the transport block. In some examples, the feedback information includes respective acknowledgement information for each of a plurality of code block groups (CGBs) of the transport block. In this example, the feedback information further includes a respective indicator of a respective demodulator type utilized for each of the plurality of CBGs for which the acknowledgement information comprises a respective NACK.

In some examples, the UE may further transmit a list of demodulator types supported by the UE. The list of demodulator types includes the demodulator type utilized by the UE in demodulating the transport block. In some examples, the UE may transmit the list of demodulator types supported by the UE within a UE capability information message. In other examples, the UE may transmit the list of demodulator types supported by the UE within a physical uplink shared channel (PUSCH) prior to radio resource control (RRC) configuration of the UE. For example, the communication and processing circuitry 1242, together with the HARQ circuitry 1246, transceiver 1210, and antenna panel(s) 1230, shown and described above in connection with FIG. 12 may provide a means to transmit the feedback information including the NACK and demodulator type indicator to the RAN node.

At block 1306, the UE may receive a retransmission of the transport block based on the NACK and the demodulator type. For example, the communication and processing circuitry 1242, together with the HARQ circuitry 1246, transceiver 1210, and antenna panel(s) 1230, shown and described above in connection with FIG. 12 may provide a means to receive the retransmission of the transport block.

In one aspect, the aforementioned means may be the processor 1204 shown in FIG. 12 configured to perform the functions recited by the aforementioned means. In another aspect, the aforementioned means may be a circuit or any apparatus configured to perform the functions recited by the aforementioned means.

Of course, in the above examples, the circuitry included in the processor 1204 is merely provided as an example, and other means for carrying out the described functions may be included within various aspects of the present disclosure, including but not limited to the instructions stored in the computer-readable storage medium 1206, or any other suitable apparatus or means described in any one of the FIGS. 1, 2, 4, and/or 7, and utilizing, for example, the processes and/or algorithms described herein in relation to FIGS. 8 and 13.

The following provides an overview of examples of the present disclosure.

Example 1: A method of wireless communication at a radio access network (RAN) node, comprising: transmitting an initial transmission of a transport block to a user equipment (UE); receiving, from the UE, feedback information comprising a negative acknowledgement (NACK) associated with the initial transmission and an indicator of a demodulator type utilized by the UE in demodulating the transport block; and transmitting a retransmission of the transport block based on the NACK and the demodulator type.

Example 2: The method of example 1, further comprising: receiving a list of demodulator types supported by the UE, wherein the list of demodulator types comprises the demodulator type utilized by the UE in demodulating the transport block.

Example 3: The method of example 2, wherein the receiving the list of demodulator types supported by the UE further comprises: receiving the list of demodulator types supported by the UE within a UE capability information message.

Example 4: The method of example 2, wherein the receiving the list of demodulator types supported by the UE further comprises: receiving the list of demodulator types supported by the JE within a physical uplink shared channel (PUSCH) prior to radio resource control (RRC) configuration of the UE.

Example 5: The method of any of examples 1 through 4, wherein the feedback information comprises respective acknowledgement information for each of a plurality of code block groups (CGBs) of the transport block.

Example 6: The method of example 5, wherein the feedback information further comprises a respective indicator of a respective demodulator type utilized for each of the plurality of CBGs for which the acknowledgement information comprises a respective NACK.

Example 7: The method of any of examples 1 through 6, further comprising: adjusting a precoding parameter based on the demodulator type and the NACK.

Example 8: The method of any of examples 1 through 7, further comprising: adjusting a redundancy version for the retransmission of the transport block based on the demodulator type and the NACK.

Example 9: The method of any of examples 1 through 8, further comprising: adjusting a modulation order for the retransmission of the transport block based on the demodulator type and the NACK.

Example 10: The method of any of examples 1 through 9, further comprising: performing an outer-loop link adaptation based on the demodulator type and the NACK.

Example 11: A radio access network (RAN) entity configured for wireless communication comprising a transceiver, a memory, and a processor coupled to the transceiver and the memory, the processor and the memory configured to perform a method of any one of examples 1 through 10.

Example 12: A radio access network (RAN) entity configured for wireless communication comprising means for performing a method of any one of examples 1 through 10.

Example 13: An article of manufacture comprising a non-transitory computer-readable medium having stored therein instructions executable by one or more processors of a radio access network (RAN) entity configured for wireless communication to perform a method of any one of examples 1 through 10.

Example 14: A method of wireless communication at a user equipment (UE), comprising: receiving an initial transmission of a transport block from a radio access network (RAN) node; transmitting, to the RAN node, feedback information comprising a negative acknowledgement (NACK) associated with the initial transmission and an indicator of a demodulator type utilized by the UE in demodulating the transport block; and receiving a retransmission of the transport block based on the NACK and the demodulator type.

Example 15: The method of example 14, further comprising: transmitting a list of demodulator types supported by the UE, wherein the list of demodulator types comprises the demodulator type utilized by the UE in demodulating the transport block.

Example 16: The method of example 15, wherein the transmitting the list of demodulator types supported by the UE further comprises: transmitting the list of demodulator types supported by the UE within a UE capability information message.

Example 17: The method of example 15, wherein the transmitting the list of demodulator types supported by the UE further comprises: transmitting the list of demodulator types supported by the UE within a physical uplink shared channel (PUSCH) prior to radio resource control (RRC) configuration of the UE.

Example 18: The method of any of examples 14 through 17, wherein the feedback information comprises respective acknowledgement information for each of a plurality of code block groups (CGBs) of the transport block.

Example 19: The method of example 18, wherein the feedback information further comprises a respective indicator of a respective demodulator type utilized for each of the plurality of CBGs for which the acknowledgement information comprises a respective NACK.

Example 20: A user equipment (UE) configured for wireless communication comprising a transceiver, a memory, and a processor coupled to the transceiver and the memory, the processor and the memory configured to perform a method of any one of examples 14 through 19.

Example 21: A user equipment (UE) configured for wireless communication comprising means for performing a method of any one of examples 14 through 19.

Example 22: An article of manufacture comprising a non-transitory computer-readable medium having stored therein instructions executable by one or more processors of a user equipment (UE) configured for wireless communication to perform a method of any one of examples 14 through 19.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-13 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 4, 7, 8, 10, and/or 12 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A radio access network (RAN) node configured for wireless communication, comprising:
a transceiver;
a memory; and
a processor coupled to the transceiver and the memory, wherein the processor and the memory are configured to:
transmit an initial transmission of a transport block to a user equipment (UE) via the transceiver;
receive, from the UE, feedback information comprising a negative acknowledgement (NACK) associated with the initial transmission and an indicator of a demodulator type utilized by the UE in demodulating the transport block via the transceiver; and
transmit a retransmission of the transport block based on the NACK and the demodulator type to the UE via the transceiver.

2. The RAN node of claim 1, wherein the processor and the memory are further configured to:
receive a list of demodulator types supported by the UE, wherein the list of demodulator types comprises the demodulator type utilized by the UE in demodulating the transport block.

3. The RAN node of claim 2, wherein the processor and the memory are further configured to:
receive the list of demodulator types supported by the UE within a UE capability information message.

4. The RAN node of claim 2, wherein the processor and the memory are further configured to:
receive the list of demodulator types supported by the UE within a physical uplink shared channel (PUSCH) prior to radio resource control (RRC) configuration of the UE.

5. The RAN node of claim 1, wherein the feedback information comprises respective acknowledgement information for each of a plurality of code block groups (CGBs) of the transport block.

6. The RAN node of claim 5, wherein the feedback information further comprises a respective indicator of a respective demodulator type utilized for each of the plurality of CBGs for which the acknowledgement information comprises a respective NACK.

7. The RAN node of claim 1, wherein the processor and the memory are further configured to:
adjust a precoding parameter based on the demodulator type and the NACK.

8. The RAN node of claim 1, wherein the processor and the memory are further configured to:
adjust a redundancy version for the retransmission of the transport block based on the demodulator type and the NACK.

9. The RAN node of claim 1, wherein the processor and the memory are further configured to:
adjust modulation order for the retransmission of the transport block based on the demodulator type and the NACK.

10. The RAN node of claim 1, wherein the processor and the memory are further configured to:
perform an outer-loop link adaptation based on the demodulator type and the NACK.

11. A method of wireless communication at a radio access network (RAN) node, comprising:
transmitting an initial transmission of a transport block to a user equipment (UE);
receiving, from the UE, feedback information comprising a negative acknowledgement (NACK) associated with the initial transmission and an indicator of a demodulator type utilized by the UE in demodulating the transport block; and
transmitting a retransmission of the transport block based on the NACK and the demodulator type.

12. The method of claim 11, further comprising:
receiving a list of demodulator types supported by the UE, wherein the list of demodulator types comprises the demodulator type utilized by the UE in demodulating the transport block.

13. The method of claim 12, wherein the receiving the list of demodulator types supported by the UE further comprises:
receiving the list of demodulator types supported by the UE within a UE capability information message.

14. The method of claim 12, wherein the receiving the list of demodulator types supported by the UE further comprises:
receiving the list of demodulator types supported by the UE within a physical uplink shared channel (PUSCH) prior to radio resource control (RRC) configuration of the UE.

15. The method of claim 11, wherein the feedback information comprises respective acknowledgement information for each of a plurality of code block groups (CGBs) of the transport block.

16. The method of claim 15, wherein the feedback information further comprises a respective indicator of a respective demodulator type utilized for each of the plurality of CBGs for which the acknowledgement information comprises a respective NACK.

17. The method of claim 11, further comprising:
adjusting a precoding parameter based on the demodulator type and the NACK.

18. The method of claim 11, further comprising:
adjusting a redundancy version for the retransmission of the transport block based on the demodulator type and the NACK.

19. The method of claim 11, further comprising:
adjusting a modulation order for the retransmission of the transport block based on the demodulator type and the NACK.

20. The method of claim 11, further comprising:
performing an outer-loop link adaptation based on the demodulator type and the NACK.

21. A user equipment (UE) configured for wireless communication, comprising:
a transceiver;
a memory; and
a processor coupled to the transceiver and the memory, wherein the processor and the memory are configured to:
receive an initial transmission of a transport block from a radio access network (RAN) node;
transmit, to the RAN node, feedback information comprising a negative acknowledgement (NACK) associated with the initial transmission and an indicator of a demodulator type utilized by the UE in demodulating the transport block; and
receive a retransmission of the transport block based on the NACK and the demodulator type.

22. The UE of claim 21, wherein the processor and the memory are further configured to:
transmit a list of demodulator types supported by the UE, wherein the list of demodulator types comprises the demodulator type utilized by the UE in demodulating the transport block.

23. The UE of claim 22, wherein the processor and the memory are further configured to:
transmit the list of demodulator types supported by the UE within a UE capability information message.

24. The UE of claim 22, wherein the processor and the memory are further configured to:
transmit the list of demodulator types supported by the UE within a physical uplink shared channel (PUSCH) prior to radio resource control (RRC) configuration of the UE.

25. The UE of claim 21, wherein the feedback information comprises respective acknowledgement information for each of a plurality of code block groups (CGBs) of the transport block.

26. The UE of claim 25, wherein the feedback information further comprises a respective indicator of a respective demodulator type utilized for each of the plurality of CBGs for which the acknowledgement information comprises a respective NACK.

27. A method of wireless communication at a user equipment (UE), comprising:
receiving an initial transmission of a transport block from a radio access network (RAN) node;
transmitting, to the RAN node, feedback information comprising a negative acknowledgement (NACK) associated with the initial transmission and an indicator of a demodulator type utilized by the UE in demodulating the transport block; and
receiving a retransmission of the transport block based on the NACK and the demodulator type.

28. The method of claim 27, further comprising:
transmitting a list of demodulator types supported by the UE, wherein the list of demodulator types comprises the demodulator type utilized by the UE in demodulating the transport block.

29. The method of claim 28, wherein the transmitting the list of demodulator types supported by the UE further comprises:
transmitting the list of demodulator types supported by the UE within a UE capability information message or a physical uplink shared channel (PUSCH) prior to radio resource control (RRC) configuration of the UE.

30. The method of claim 27, wherein the feedback information comprises respective acknowledgement information for each of a plurality of code block groups (CGBs) of the transport block and a respective indicator of a respective demodulator type utilized for each of the plurality of CBGs for which the acknowledgement information comprises a respective NACK.
